(19) United States
(12) Patent Application Publication
(10) Pub. No.: US 2026/0340310 A1
(43) Pub. Date: Oct. 29, 2026

(54) TOKEN LEVEL CONTEXT ATTRIBUTION

(71) Applicant: Bytedance Technology Ltd., Grand Cayman (KY)

(72) Inventors: Yingtai XIAO, CULVER CITY, CA (US); Sirat SAMYOUN, CULVER CITY, CA (US); Wanrong ZHANG, CULVER CITY, CA (US); Jian DU, CULVER CITY, CA (US)

(21) Appl. No.: 19/193,498

(22) Filed: Apr. 29, 2025

(51) Int. Cl. G06F 40/40

(52) U.S. Cl. CPC G06F 40/40

(57) ABSTRACT

The present disclosure involves methods, apparatus, and systems for token level context attribution including identifying a context provided as input to a language model (LM), the context comprising a plurality of input tokens arranged in a sequence; identifying a datastore of key-value pairs, wherein each key in the datastore represents a first hidden state associated with a subset of the plurality of input tokens, and wherein each value represents a corresponding next token in the sequence; assigning a Shapely value for each input token of the plurality of input tokens by: selecting a Shapely value for each input token arranged in the sequence based on similarity scores.

### TECHNICAL FIELD

The present disclosure generally relates to determining attribution for input tokens to a generative AI model.

### BACKGROUND

Determining the inputs used by an AI model during inference, especially complex deep learning models, can be challenging due to the intricate architectures and training processes of the models. These models often learn relationships within vast datasets, making it difficult to isolate the specific features or combinations of inputs that most significantly influence their outputs. Furthermore, the internal workings of many AI models can often be considered “black boxes,” where the learned representations and decision-making processes are not easily interpretable, obscuring the role of individual input variables.

### SUMMARY

The present disclosure relates to a method, system, and computer-readable storage media for token level context attribution including identifying a context provided as input to a language model (LM), the context comprising a plurality of input tokens arranged in a sequence; identifying a datastore of key-value pairs, wherein each key in the datastore represents a first hidden state associated with a subset of the plurality of input tokens, and wherein each value represents a corresponding next token in the sequence; assigning a Shapely value for each input token of the plurality of input tokens by: identifying, for a plurality of response tokens from an inference of the LM performed based on the context, a second hidden state associated with a subset of response tokens; querying the datastore by using a K-nearest neighbor (KNN) algorithm and the second hidden state to find a set of candidate predicted tokens; assigning a similarity score for each candidate predicted token based on a utility function and the plurality of input tokens; and selecting a Shapely value for each input token arranged in the sequence based on the similarity scores. Implementations can optionally include one or more of the following features.

In some instances, the first hidden state is an encoding of the embeddings of an adjacent subset of the input tokens in the sequence.

In some instances, the second hidden state is an encoding of the embeddings of an adjacent subset of the response tokens.

In some instances, the utility function assigns a binary similarity of one or zero for each candidate predicted token.

In some instances, the utility function is:

$$v ( S ; {\hat{z}}_{t} ) = \{ \begin{matrix}1 , & {\sum }_{j = 1}^{{K}^{S}} s ( h ( {\hat{x}}_{t} ) , h ( {x}_{j}^{S} ) ) 𝕀 [ {y}_{j}^{S} = {\hat{y}}_{t} ] \geq \\ & {\sum }_{j = 1}^{{K}^{S}} s ( h ( {\hat{x}}_{t} ) , h ( {x}_{j}^{S} ) ) 𝕀 [ {y}_{j}^{S} \neq {\hat{y}}_{t} ] \\ 0 , & otherwise\end{matrix} .$$

In some instances, the Shapely value for each input token is selected based on a counting of whether each input token changes the value of the utility function, wherein the counting is defined as [symbol] .

In some instances, the Shapely value for a given token zᵢ is assigned as:

$${ϕ}_{{z}_{i} \to \hat{z}} ( v ) = \frac{2 𝕀 [ {y}_{i} = \hat{y} ] - 1}{N} {\sum }_{ℓ = 0}^{N - 1} \frac{{𝒢}_{i , ℓ}}{( \begin{matrix}N - 1 \\ ℓ\end{matrix} )} .$$

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for performing token level context attribution.

FIG. 2 is a flowchart illustrating an example process for performing token level context attribution.

FIG. 3 is an example table set showing a token level context attribution applied to an input.

FIG. 4 illustrates a schematic diagram of an example computing system.

Like reference numbers and designations in the various drawings indicate like elements.

### DETAILED DESCRIPTION

This specification relates to performing token level context attribution. In context learning (ICL) has emerged as a powerful capability of generative AI, such as language models (LMs), sometimes referred to as large language models (LLMs). LLMs can perform a wide range of tasks (for example, answering questions, or solving math problems) by learning from the context information provided by users. ICL is particularly valuable in scenarios where data collection and retraining are costly or impractical (such as medical diagnoses applications).

However, responses generated by large language models (LLMs) are not necessarily grounded in truth, as these models can sometimes hallucinate, or produce factually incorrect or misleading information. This can lead to risks or poor performance, especially in high-stakes applications (e.g., healthcare diagnosis). As such, fact-checking and context attribution are important to ensure that LLM responses are both interpretable and verifiable. For example, if an LLM is trained to recommend medication based on a medical database, and the LLM responds with “Yes, medication X reduces migraine frequency effectively, but long-term use may cause liver toxicity.” A user may want to get information about key tokens, such as “migraine frequency” and “liver toxicity”, that capture comprehensive evidence of both benefits and risks, which might be overlooked with a single attributed sentence. By identifying the tokens motivating a response and providing supporting attribution, users can more easily assess the response's reliability.

Conventional attribution techniques utilize search engines, document retrieval systems, or surrogate models to retrieve evidence based on input questions and generated answers. They primarily attribute information at the sentence level, which lacks fine-grained attribution when a sentence contains multiple pieces of information.

This disclosure introduces a new attribution technique that: 1) Provides accurate evidence, 2) eliminates the need for additional tuning with LLMs, and 3) enables fine-grained attribution. This can be accomplished with the Shapley value, which fairly attributes contributions by distributing credit among input components based on their marginal impact. In some implementations, when a K-nearest neighbors (KNN) model is used for attribution, Shapley values can be computed in polynomial time. However, applying a KNN model for attribution in LLMs can be challenging due to the vague notion of “labels” among tokens.

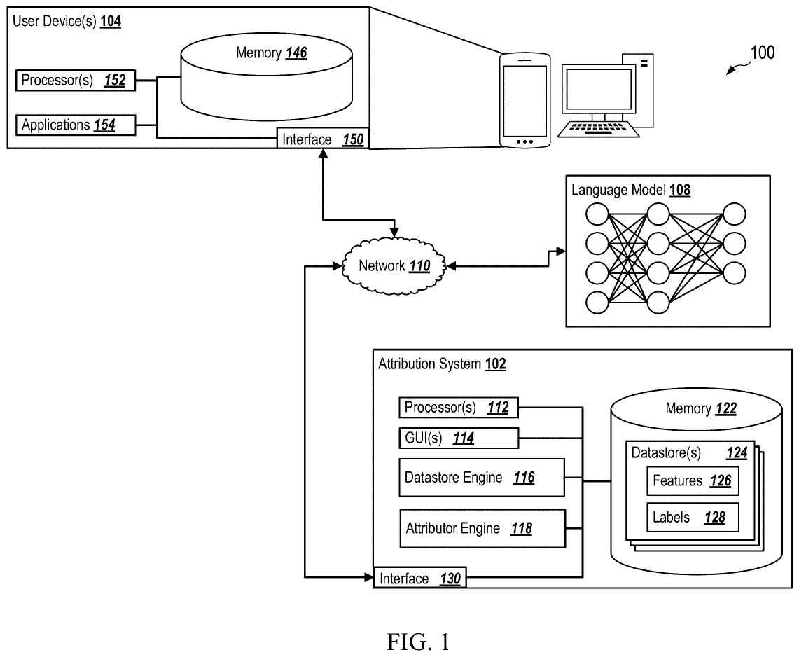

FIG. 1 illustrates a block diagram of an example system 100 for performing token level context attribution. The system 100 includes an attribution system 102, one or more user devices 104, and a language model 108, which can communicate using a network 110.

Network 110 facilitates wireless or wireline communications between the components of the system 100 (e.g., between the attribution system 102, and the user devices 104), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the language model 108 and the memory 122) can be included within or deployed to network 110 or a portion thereof as one or more cloud-based services or operations. The network 110 can be all or a portion of an enterprise or secured network, while in another instance, at least a portion of the network 100 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, worldwide interoperability for microwave access (WiMax), long-term evolution (LTE), and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

The language model 108 can be deployed within the network 110 or may be deployed on other devices. The language model 108 may be based on any suitable model structure including, but not limited to, a Transformer model, a convolutional neural network (CNN), a recurrent neural network (RNN), a deep neural network (DNN), or the like. In some implementations, the language model 108 is a commercially available LLM or another specifically designed or trained generative AI model. Generally, given a query q and a corpus of text data or input data (context) with N tokens, D=(z₁, . . . , z_{N}), the language model generates a response R with T tokens R=(\hat{z}₁, . . . , \hat{z}_{T}).

The attribution system 102 can be a server- or web-based system that determines an attribution for each response token from the LLM's 108 response. For each response token \hat{z}∈R, the attribution system 102 will identify the most contributive tokens z∈D. To achieve this, a score φ_{z→2} can be computed to quantify the contribution of z to \hat{z}. Tokens z with the highest scores φ_{z→2} can then be selected as the attribution for the token \hat{z}.

The attribution system 102 can include one or more processors 112, a graphical user interface (GUI) 114, a datastore engine 116, and a verification engine 118. The attribution system 102 can also include a memory 122, which can store one or more datastores 124, which can include features 126 and labels 128 associated with an input context D.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the attribution system 102. Specifically, the processor 112 executes the algorithms and operations described in the illustrated figures, as well as the various software modules and functionality, including the functionality for sending communications to and receiving transmissions from the language model 108, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the certificate verification system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including Python, C, C++, JavaScript, Java™, Visual Basic, assembler, Perl®, any suitable version of fourth-generation programming language (4GL), as well as others.

GUI 114 of the attribution system 102 interfaces with at least a portion of the system 100 for any suitable purpose, including generating a visual representation of any particular application or results and/or the content associated with any components of the user devices 104 or attribution in general. In particular, the GUI 114 can be used to present results of an attribution analysis, or allow a developer to review the system status and overall function of the attribution system 102, as well as to otherwise interact and present information associated with one or more applications. GUI 114 can also be used to view and interact with various web pages, applications, and web services located local or external to the attribution system 102. Generally, the GUI 114 provides the user with an efficient and user-friendly presentation of data provided by or communicated within the system. The GUI 114 can include a plurality of customizable frames or views having interactive fields, pull-down lists, and buttons operated by the user. In general, the GUI 114 is often configurable, supports a combination of tables and graphs (e.g., bar, line, pie, and/or status dials), and is able to build real time portals, application windows, and presentations. Therefore, the GUI 114 contemplates any suitable GUI, such as a combination of a generic web browser, a web-enabled application, intelligent engine, and command line interface (CLI) that processes information in the platform and efficiently presents the results to the user visually.

Memory 122 can represent a single memory or multiple memories. The memory 122 can include any memory or database module and can take the form of volatile or non-volatile memory including, without limitation, magnetic media, optical media, random access memory (RAM), read-only memory (ROM), removable media, or any other suitable local or remote memory component. The memory 122 can store various objects or data, including digital asset data, public keys, user and/or account information, administrative settings, password information, caches, applications, backup data, repositories storing business and/or dynamic information, and any other appropriate information associated with the attribution system 102, including any parameters, variables, algorithms, instructions, rules, constraints, or references thereto. Additionally, the memory 112 can store any other appropriate data, such as datastore 124, user profiles, algorithms, or processes, firmware logs and policies, firewall policies, a security or access log, print or other reporting files, as well as others. While illustrated within the system 100, memory 122 or any portion thereof, including some or all of the particular illustrated components, can be located remote from the system 100 in some instances, including as a cloud application or repository or as a separate cloud application or repository when the system 100 itself is a cloud-based system.

The datastore engine 116 can be an application or script or software that generates a datastore for use by the attribute engine 118. The datastore can store input contexts in a key-value pair data structure. In some implementations, with each new input to the language model 108 a datastore 124 is created. The input can be a string of text, or series of words and/or images that are tokenized for processing by the language model 108. As describe above, in some implementations, the input is referred to as a “context” D. There can be a number of sequential tokens for any given context D.

For examples, if are N tokens in the context than D=(z₁, . . . , z_{N}). For the t-th token zₜ, the “prefix” of zₜ can be defined as xₜ=(zₜ_{₀}, zₜ_{₀}₊₁, . . . , zₜ₋₁). Where to is the starting index for the prefix. In some implementations, for example, to can be set as the index for the starting token at the current sentence of zₜ. In some implementations, to can be set as the beginning of the context D. In some implementations, for each data point zₜ∈D a (feature, label) is defined pair which can be represented by the (prefix, token) pair zₜ→(xₜ,yₜ). The label, yₜ, can be the next token following xₜ, in other words the label can be defined as yₜ=zₜ. The language model's embedding model encoder, h(⋅) can then be used to encode each prefix sentence xₜ into a hidden states h(xₜ). Therefore, for a token zₜ∈D, the datastore engine 116 can save key-value pairs in datastore 124 as ( [symbol] , [symbol] )={(h(xₜ),yₜ)|zₜ∈D}. In these instances, The size of the datastore is proportional to the total number of tokens within D. In this store, each key [symbol] of the key value pair is a feature 126, and each value [symbol] is a label 128.

In some implementations, the datastore engine 116 generates a new datastore 124 for each new input context provided to the language model 108. In some implementations, a datastore 124 is only generated upon request (e.g., from a user device 104, or the attributor engine 118).

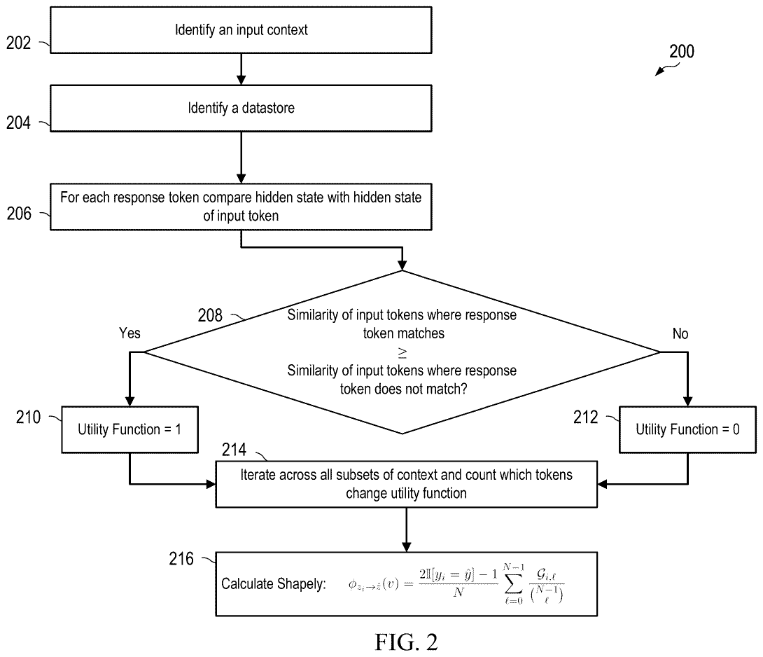

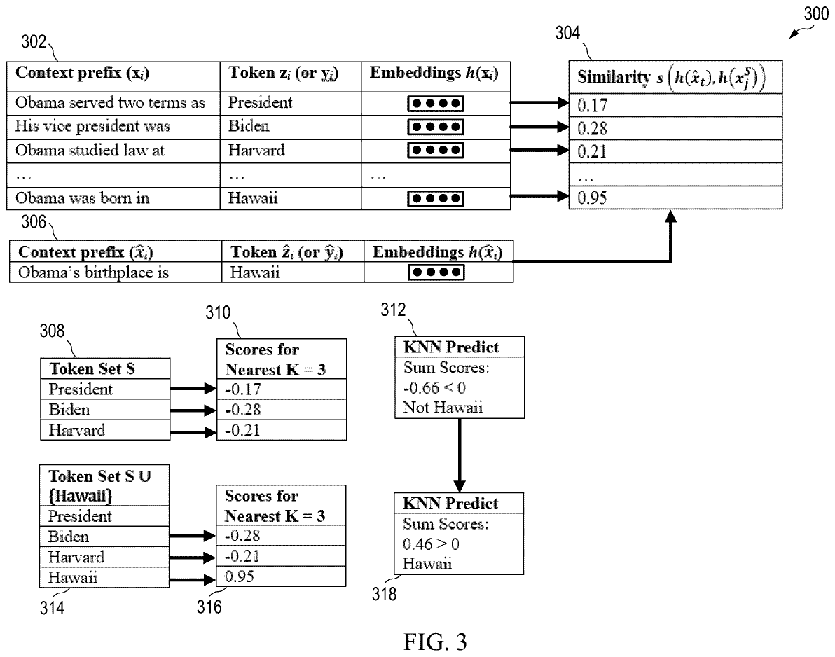

The attributor engine 118 then uses the datastore 124 and a response from the language model 108 to the input context, and generates and attribution for each token in the input context. This is performed by calculating a similarity score using a utility function for each output token and then using that similarity score to perform a weighted KNN-Shapely algorithm to calculate a Shapley value, or attribution value for each token. This process is described in further detail below with respect to FIGS. 2 and 3.

Interface 130 is used by the attribution system 102 to communicate with other systems in a distributed environment—including within the system 100—connected to the network 110 (e.g., user devices 104), and other systems communicably coupled to the illustrated certificate verification system 102 and/or network 110. Generally, the interface 130 includes logic encoded in software and/or hardware in a suitable combination and operable to communicate with the network 110 and other components. More specifically, the interface 130 can include software supporting one or more communication protocols associated with communications such that the network 110 and/or interface's 130 hardware is operable to communicate physical signals within and outside of the illustrated system 100. Still further, the interface 130 can allow the attribution system 102 to communicate with the user devices 104, language model 108, and/or other portions illustrated within the system 100 to perform the operations described herein.

User devices 104 can be computing devices or computers used by one or more users and developers of the software and hardware within system 100. For example, the user devices 104 can interact with the attribution system 102 to get context attribution for responses provided from the language model 108. In another example, user devices 104 can be used to query or prompt the language model 108 and receive responses. As used in the present disclosure, the term “computer” or “computing devices” is intended to encompass any suitable processing device. For example, the user devices 104 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. The user devices 104, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 104 can include one or more specific applications 154 executing on the user devices 104, or the user devices 104 can include one or more Web browsers or web applications that can interact with particular applications executing remotely from the user devices 104. User devices 104 can include a memory 146, which can be similar to or different from memory 122. The user devices 104 can include an interface 150 which enables communication with other components of system 100, and can be similar to interface 130.

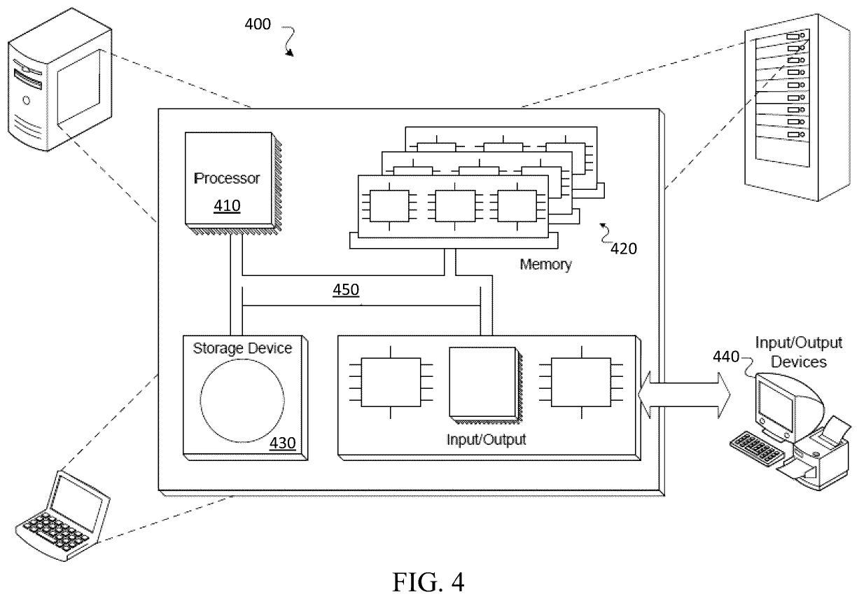

FIG. 2 is a flowchart illustrating an example process 200 for performing token level context attribution. The example process 200 can be performed by a system for example, system 100 as described above with respect to FIG. 1. The operations shown in process 200 may not be exhaustive and other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 400 of FIG. 4, appropriately programmed, can perform the process 200.

At 202, an input context for attribution is identified. In some implementations, this context is identified by a request from a user device or in response to a prompt or query arriving at a language model. In some implementations, the input context is a tokenized prompt, that is, the input context includes a number of sequential tokens that are to be provided to a language model in order to elicit a sequence of response tokens.

At 204, a datastore is identified. The datastore can correspond to the input prompt and include a number of key-value pairs that are constructed based on the input prompt. In some implementations, each key in the datastore is a hidden state representing a prefix for a given token in the context. The hidden state can be generated using the embedding model of the language model, and the prefix can be a sequence of tokens leading up to, and adjacent to the token of interest represented by the key. Each value in the datastore can be a corresponding next token in the sequence that follows the token of interest. In some implementations, these key-value pairs are considered feature and label pairs respectively during follow on calculations.

At 206, each response token in the input context is analyzed and compared with the datastore. For example, once an inference has been executed, the response to that inference can be received as a set of tokens R=(\hat{z}₁, . . . , \hat{z}₇). The hidden state with respect to these response tokens can then be determined by taking the embedding of the prefix for each token, similarly to the input context. This will give a hidden state h(\hat{x}ₜ). This can be compared, for each token t with the hidden state of the input context, h(xⱼ). In some implementations, the prefix to be compared xⱼ is selected from a subset of the entire input context D by performing a KNN matching algorithm against the datastore using h(\hat{x}ₜ) to search the keys of the datastore.

At 208, a utility function is applied to the tokens to determine a score for each token. A similarity algorithm s(h(\hat{x}ₜ),h(xⱼ)) can be performed for each input prefix found in the subset S. Similarity algorithms can include, but are not limited to Euclidean distance, cosine similarity, L1 similarity, or other algorithms. When the corresponding next token (or label) ŷₜ and yⱼ are equal, that similarity can be summed with other similarities that have equal labels, and then compared to the sum of the similarities with unequal similarities, for the searched subset of the input context D. This score v(S;\hat{z}ₜ) can be calculated for each response token and can be assigned as either zero (212) or one (210) based on whether the similarity where the labels are equal is greater than the similarity where the labels are not equal. This utility function can be written as:

$$v ( S ; {\hat{z}}_{t} ) = \{ \begin{matrix}1 , & {\sum }_{j = 1}^{{K}^{S}} s ( h ( {\hat{x}}_{t} ) , h ( {x}_{j}^{S} ) ) 𝕀 [ {y}_{j}^{S} = {\hat{y}}_{t} ] \\ & \geq {\sum }_{j = 1}^{{K}^{S}} s ( h ( {\hat{x}}_{t} ) , h ( {x}_{j}^{S} ) ) 𝕀 [ {y}_{j}^{S} \neq {\hat{y}}_{t} ] \\ 0 , & otherwise\end{matrix} .$$

In this utility function, j is an index for summation within subset S. The summation is calculated for each index j within the subset.

At 214, the score above is calculated for each response token \hat{z}ₜ and a count can be performed each time a new token changes the value of the score (e.g., from 0 to 1, from 1 to 0), This can a be expressed as:

$$v ( S ⋃ \{ {z}_{i} \} ) - v ( S ) = \{ \begin{matrix}1 & if {y}_{i} , {Cond}_{KNN} , {Cond}_{0 \to 1} \\ - 1 & if {y}_{i} , {Cond}_{KNN} , {Cond}_{1 \to 0} \\ 0 & Otherwise\end{matrix}$$

This count increments by positive 1 if yⱼ=ŷ, and the analyzed token is part of the subset S resulting from the KNN search (Cond_{KNN}), as well as if the addition of the token changes the utility function v(S;\hat{z}ₜ) from a zero to a one (Cond_{0→1}). The count increments by a negative 1 if yᵢ≠ŷ, the token is part of the subset S (Cond_{KNN}), and it changes the utility function from a one to a zero (Cond_{1→0}).

This count of subsets from this equation, S⊆D\{zᵢ}, can be labeled [symbol] for a size [symbol] that satisfy both conditions: (1) Cond_{KNN}, and (2) Cond_{0→1} if yᵢ=ŷ, or Cond_{1→0} if yᵢ≠ŷ.

At 216, with this count complete, the shapely value for each token φ_{z}_{ᵢ}_{→\hat{z}}(v) can be calculated:

$${ϕ}_{{z}_{i} \to \hat{z}} ( v ) = \frac{2 𝕀 [ {y}_{i} = \hat{y} ] - 1}{N} {\sum }_{ℓ = 0}^{N - 1} \frac{{𝒢}_{i , ℓ}}{( \begin{matrix}N - 1 \\ ℓ\end{matrix} )}$$

Because these are Shapely values, they can be aggregated readily. For example, to determine the attribution from a set of context tokens zᵢ∈S (e.g., a sentence in the context) to a set of response tokens \hat{z}∈Ŝ (e.g., the entire response). This can be accomplished by summing the individual Shapley value scores. Since φ_{z}_{ᵢ}_{→\hat{z}}(v) measures the contribution of a data point zᵢ∈D for a specific token \hat{z}, to compute the Shapley value over the token set Ŝ of interest, the linearity property of Shapely can be relied upon. Specifically, by summing the individual Shapley values for each validation point. φ_{z}_{ᵢ}_{→Ŝ}(v):=Σ_{\hat{z}∈Ŝ}φ_{z}_{ᵢ}_{→\hat{z}}(v). Following that the Shapley values in the context token sets S can be summed to yield the attribution from S to Ŝ. φ_{S→Ŝ}(v): Σ_{\hat{z}}_{ᵢ}_{∈S}φ_{z}_{ᵢ}_{→Ŝ}(v). This gives the formula, φ_{S→Ŝ}(v):=Σ_{\hat{z}}_{ᵢ}_{∈S}Σ_{\hat{z}∈Ŝφ}_{z}_{ᵢ}_{→\hat{z}}(v).

FIG. 3 is an example table set showing a token level context attribution applied to an input. Table 302 shows several example context prefixes (or features) in the first column with their associated next token (or label) in the second column. Each of these prefixes will form a hidden state by being embedded as shown in the third column.

Table 306 illustrates the same three columns for a set of response tokens received from an inference process of a language model. The hidden state for the response is compared to the hidden state of each prefix using a similarity algorithm in table 304. As shown, the similarity of the hidden states for prefixes “Obama's birthplace is” and “Obama was born in” is very high. Considering the token set S shown in table 308, the similarity scores are shown in table 310. The Shapely value for this set is calculated as −0.66 shown in 312, which is less than zero. However, when “Hawaii” is added to the considered token set at 314, the similarity values changes as shown in table 316, and the Shapely score increases to 0.46 as shown in 318.

Given a response token \hat{z}, similarity scores are first computed using the datastore. To determine the Shapley value of a context token zᵢ, all possible subsets S⊆D\{zᵢ} can be selected. Then a KNN classifier can be executed on both S and S∪{zᵢ} to evaluate whether adding zᵢ improves the accuracy of predicting \hat{z}. If the accuracy increases, zᵢ is assigned a higher Shapley value.

FIG. 4 illustrates a schematic diagram of an example computing system 400. The system 400 can be used for the operations described in association with the implementations described herein. For example, the system 400 may be included in computing devices of the one or more online components and/or the one or more offline components. The system 400 includes a processor 410, a memory 420, a storage device 430, and an input/output device 440, which are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A computer-implemented method, comprising:
identifying a context provided as input to a language model (LM), the context comprising a plurality of input tokens arranged in a sequence;
identifying a datastore of key-value pairs, wherein each key in the datastore represents a first hidden state associated with a subset of the plurality of input tokens, and wherein each value represents a corresponding next token in the sequence;
assigning a Shapely value for each input token of the plurality of input tokens by:
identifying, for a plurality of response tokens from an inference of the LM performed based on the context, a second hidden state associated with a subset of response tokens;
querying the datastore by using a K-nearest neighbor (KNN) algorithm and the second hidden state to find a set of candidate predicted tokens;
assigning a similarity score for each candidate predicted token based on a utility function and the plurality of input tokens; and
selecting a Shapely value for each input token arranged in the sequence based on the similarity scores.

2. The method of claim 1, wherein the first hidden state is an encoding of the embeddings of an adjacent subset of the input tokens in the sequence.

3. The method of claim 1, wherein the second hidden state is an encoding of the embeddings of an adjacent subset of the response tokens.

4. The method of claim 1, wherein the utility function assigns a binary similarity of one or zero for each candidate predicted token.

5. The method of claim 4, wherein the utility function is:
$$v ( S ; {\hat{z}}_{t} ) = \{ \begin{matrix}1 , & {\sum }_{j = 1}^{{K}^{S}} s ( h ( {\hat{x}}_{t} ) , h ( {x}_{j}^{S} ) ) 𝕀 [ {y}_{j}^{S} = {\hat{y}}_{t} ] \geq \\ & {\sum }_{j = 1}^{{K}^{S}} s ( h ( {\hat{x}}_{t} ) , h ( {x}_{j}^{S} ) ) 𝕀 [ {y}_{j}^{S} \neq {\hat{y}}_{t} ] \\ 0 , & otherwise\end{matrix} .$$

6. The method of claim 1, wherein the Shapely value for each input token is selected based on a counting of whether each input token changes the value of the utility function, wherein the counting is defined as [symbol] .

7. The method of claim 6, wherein the Shapely value for a given token zᵢ is assigned as:
$${ϕ}_{{z}_{i} \to \hat{z}} ( v ) = \frac{2 𝕀 [ {y}_{i} = \hat{y} ] - 1}{N} {\sum }_{ℓ = 0}^{N - 1} \frac{{𝒢}_{i , ℓ}}{( \begin{matrix}N - 1 \\ ℓ\end{matrix} )} .$$

8. One or more computer-readable storage medium storing one or more instructions that, when executable by one or more computers, cause the one or more computers to perform operations comprising:
identifying a context provided as input to a language model (LM), the context comprising a plurality of input tokens arranged in a sequence;
identifying a datastore of key-value pairs, wherein each key in the datastore represents a first hidden state associated with a subset of the plurality of input tokens, and wherein each value represents a corresponding next token in the sequence;
assigning a Shapely value for each input token of the plurality of input tokens by:
identifying, for a plurality of response tokens from an inference of the LM performed based on the context, a second hidden state associated with a subset of response tokens;
querying the datastore by using a K-nearest neighbor (KNN) algorithm and the second hidden state to find a set of candidate predicted tokens;
assigning a similarity score for each candidate predicted token based on a utility function and the plurality of input tokens; and
selecting a Shapely value for each input token arranged in the sequence based on the similarity scores.

9. The medium of claim 8, wherein the first hidden state is an encoding of the embeddings of an adjacent subset of the input tokens in the sequence.

10. The medium of claim 8, wherein the second hidden state is an encoding of the embeddings of an adjacent subset of the response tokens.

11. The medium of claim 8, wherein the utility function assigns a binary similarity of one or zero for each candidate predicted token.

12. The medium of claim 11, wherein the utility function is:
$$v ( S ; {\hat{z}}_{t} ) = \{ \begin{matrix}1 , & {\sum }_{j = 1}^{{K}^{S}} s ( h ( {\hat{x}}_{t} ) , h ( {x}_{j}^{S} ) ) 𝕀 [ {y}_{j}^{S} = {\hat{y}}_{t} ] \\ & \geq {\sum }_{j = 1}^{{K}^{S}} s ( h ( {\hat{x}}_{t} ) , h ( {x}_{j}^{S} ) ) 𝕀 [ {y}_{j}^{S} \neq {\hat{y}}_{t} ] \\ 0 , & otherwise\end{matrix} .$$

13. The medium of claim 8, wherein the Shapely value for each input token is selected based on a counting of whether each input token changes the value of the utility function, wherein the counting is defined as [symbol] .

14. The medium of claim 13, wherein the Shapely value for a given token zᵢ is assigned as:
$${ϕ}_{{z}_{i} \to \hat{z}} ( v ) = \frac{2 𝕀 [ {y}_{i} = \hat{y} ] - 1}{N} {\sum }_{ℓ = 0}^{N - 1} \frac{{𝒢}_{i , ℓ}}{( \begin{matrix}N - 1 \\ ℓ\end{matrix} )} .$$

15. A computer-implemented system, comprising:
one or more computers; and
one or more computer memory devices interoperably coupled with the one or more computers and having computer-readable storage media storing one or more instructions that, when executed by the one or more computers, perform one or more operations comprising:
identifying a context provided as input to a language model (LM), the context comprising a plurality of input tokens arranged in a sequence;
identifying a datastore of key-value pairs, wherein each key in the datastore represents a first hidden state associated with a subset of the plurality of input tokens, and wherein each value represents a corresponding next token in the sequence;
assigning a Shapely value for each input token of the plurality of input tokens by:
identifying, for a plurality of response tokens from an inference of the LM performed based on the context, a second hidden state associated with a subset of response tokens;
querying the datastore by using a K-nearest neighbor (KNN) algorithm and the second hidden state to find a set of candidate predicted tokens;
assigning a similarity score for each candidate predicted token based on a utility function and the plurality of input tokens; and
selecting a Shapely value for each input token arranged in the sequence based on the similarity scores.

16. The system of claim 15, wherein the first hidden state is an encoding of the embeddings of an adjacent subset of the input tokens in the sequence.

17. The system of claim 15, wherein the second hidden state is an encoding of the embeddings of an adjacent subset of the response tokens.

18. The system of claim 15, wherein the utility function assigns a binary similarity of one or zero for each candidate predicted token.

19. The system of claim 18, wherein the utility function is:
$$v ( S ; {\hat{z}}_{t} ) = \{ \begin{matrix}1 , & {\sum }_{j = 1}^{{K}^{S}} s ( h ( {\hat{x}}_{t} ) , h ( {x}_{j}^{S} ) ) 𝕀 [ {y}_{j}^{S} = {\hat{y}}_{t} ] \geq \\ & {\sum }_{j = 1}^{{K}^{S}} s ( h ( {\hat{x}}_{t} ) , h ( {x}_{j}^{S} ) ) 𝕀 [ {y}_{j}^{S} \neq {\hat{y}}_{t} ] \\ 0 , & otherwise\end{matrix} .$$

20. The system of claim 15, wherein the Shapely value for each input token is selected based on a counting of whether each input token changes the value of the utility function, wherein the counting is defined as [symbol] .
